(19) United States
(12) Patent Application Publication
(10) Pub. No.: US 2019/0287285 A1
(43) Pub. Date: Sep. 19, 2019

(54) INFORMATION PROCESSING DEVICE, INFORMATION PROCESSING METHOD, AND PROGRAM

(71) Applicant: SONY CORPORATION, TOKYO (JP)

(72) Inventor: TSUYOSHI ISHIKAWA, KANAGAWA (JP)

(21) Appl. No.: 16/347,006

(22) PCT Filed: Sep. 11, 2017
(86) PCT No.: PCT/JP2017/032617

§ 371 Date: May 2, 2019

(30) Foreign Application Priority Data
Dec. 12, 2016 (JP) 2016-240011

(51) Int. Cl. G06T 11/60; G06F 3/0488; G06F 3/0484; G06F 3/01; G06T 3/60

(52) U.S. Cl. CPC G06T 11/60; G06F 3/04883; G06T 3/60; G06F 3/016; G06F 3/04842; G06F 3/04845

(57) ABSTRACT

[Object] To propose an information processing device, an information processing method, and a program capable of controlling display of an image adapted to a user's motion in displaying a virtual object. [Solution] An information processing device including: an acquisition unit configured to acquire motion information of a user with respect to a virtual object displayed by a display unit; and an output control unit configured to control display of an image including an onomatopoeic word depending on the motion information and the virtual object.

### TECHNICAL FIELD

The present disclosure relates to an information processing device, an information processing method, and a program.

### BACKGROUND ART

In related art, various techniques have been provided for presenting, in one example, tactile stimulation such as vibration to a user.

In one example, Patent Literature 1 below discloses a technique of controlling output of sound or tactile stimulation depending on granularity information of a contact surface between two objects in a case where the objects are relatively moved in a state in which the objects are in contact with each other in the virtual space.

### CITATION LIST

### Patent Literature

Patent Literature 1: JP 2015-170174A

### DISCLOSURE OF INVENTION

### Technical Problem

However, the technique disclosed in Patent Literature 1 remains the picture to be displayed unchanged even in a case of varying the user's motion in displaying an object in a virtual space.

In view of this, the present disclosure provides a novel and improved information processing device, information processing method, and program, capable of controlling display of an image adapted to the user's motion in displaying a virtual object.

### Solution to Problem

According to the present disclosure, there is provided an information processing device including: an acquisition unit configured to acquire motion information of a user with respect to a virtual object displayed by a display unit; and an output control unit configured to control display of an image including an onomatopoeic word depending on the motion information and the virtual object.

Moreover, according to the present disclosure, there is provided an information processing method including: acquiring motion information of a user with respect to a virtual object displayed by a display unit; and controlling, by a processor, display of an image including an onomatopoeic word depending on the motion information and the virtual object.

Moreover, according to the present disclosure, there is provided a program causing a computer to function as: an acquisition unit configured to acquire motion information of a user with respect to a virtual object displayed by a display unit; and an output control unit configured to control display of an image including an onomatopoeic word depending on the motion information and the virtual object.

### Advantageous Effects of Invention

According to the present disclosure as described above, it is possible to control display of an image adapted to the user's motion in displaying a virtual object. Moreover, the effects described herein are not necessarily limited, and any of the effects described in the present disclosure may be applied.

### BRIEF DESCRIPTION OF DRAWINGS

FIG. 1 is a diagram illustrated to describe a configuration example of an information processing system according to an embodiment of the present disclosure.

FIG. 2 is a functional block diagram illustrating a configuration example of an information processing device 10 according to the present embodiment.

FIG. 3 is a diagram illustrated to describe a configuration example of an object DB 124 according to the present embodiment.

FIG. 4 is a diagram illustrating a display example of an onomatopoeic word when a user touches a virtual object displayed on an HMD 30.

FIG. 5 is a diagram illustrating a display example of an onomatopoeic word when a user touches a virtual object displayed on the HMD 30.

FIG. 6 is a diagram illustrating a display example of an onomatopoeic word when a user touches a virtual object displayed on the HMD 30.

FIG. 7 is a diagram illustrating a display example of a display effect when a user touches a virtual object displayed on the HMD 30.

FIG. 8 is a sequence diagram illustrating a part of a processing procedure according to the present embodiment.

FIG. 9 is a sequence diagram illustrating a part of a processing procedure according to the present embodiment.

FIG. 10 is a flowchart illustrating a procedure of “control method determination processing” according to the present embodiment.

FIG. 11 is a diagram illustrated to describe a configuration example of an information processing system according to an application example of the present embodiment.

FIG. 12 is a diagram illustrating a display example of an onomatopoeic word when the one user touches a virtual object in a situation where the other user is not viewing the virtual object according to the present application example.

FIG. 13 is a diagram illustrating a display example of an onomatopoeic word when the one user touches a virtual object in a situation where the other user is viewing the virtual object according to the present application example.

FIG. 14 is a diagram illustrated to describe a hardware configuration example of the information processing device 10 according to the present embodiment.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

In addition, there are cases in the present specification and the diagrams in which a plurality of components having substantially the same functional configuration is distinguished from each other by affixing different letters to the same reference numbers. In one example, a plurality of components having substantially identical functional configuration is distinguished, like a stimulation output unit 20a and a stimulation output unit 20b, if necessary. However, when there is no particular need to distinguish a plurality of components having substantially the same functional configuration from each other, only the same reference number is affixed thereto. In one example, when there is no particular need to distinguish the stimulation output unit 20a and the stimulation output unit 20b, they are referred to simply as a stimulation output unit 20.

Further, the “modes for carrying out the invention” will be described in the order of items shown below.

1. Configuration of information processing system
2. Detailed description of embodiment
3. Hardware configuration

### 4. Modifications

### 1. Configuration of Information Processing System

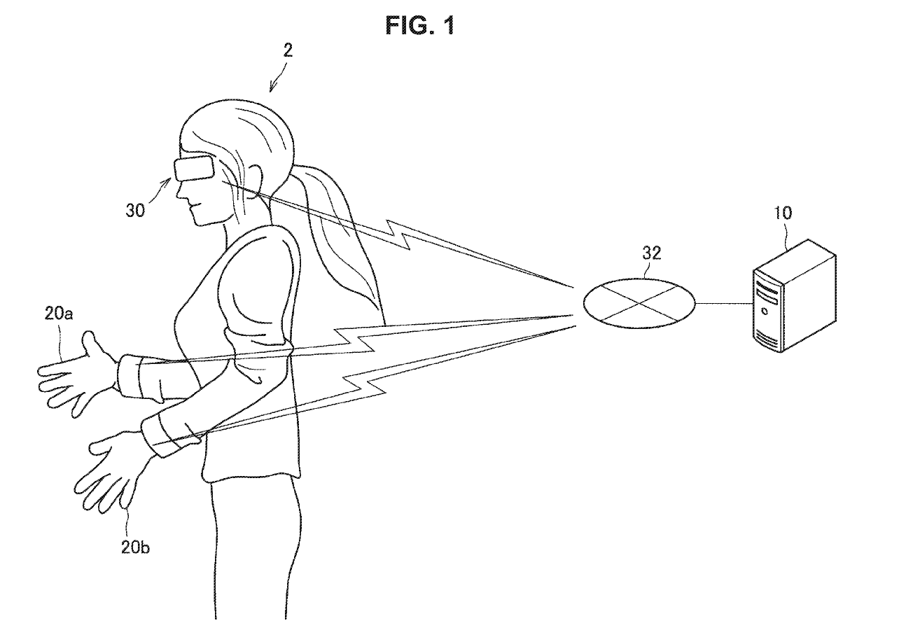

The configuration of an information processing system according to an embodiment of the present disclosure is now described with reference to FIG. 1. As illustrated in FIG. 1, the information processing system according to the present embodiment includes an information processing device 10, a plurality of types of stimulation output units 20, and a communication network 32.

### 1-1. Stimulation Output Unit 20

### 1-1-1. Output of Tactile Stimulation

The stimulation output unit 20 may be, in one example, an actuator for presenting a desired skin sensation to the user. The stimulation output unit 20 outputs, in one example, stimulation relating to the skin sensation in accordance with control information received from the information processing device 10 to be described later. Here, the skin sensation may include, in one example, tactile sensation, pressure sensation, thermal sensation, and pain sensation. Moreover, the stimulation relating to the skin sensation is hereinafter referred to as tactile stimulation. In addition, the output of the tactile stimulation may include generation of vibration.

Further, the stimulation output unit 20 can be attached to a user (e.g., a user's hand or the like) as illustrated in FIG. 1. In this case, the stimulation output unit 20 can output tactile stimulation to a part (e.g., hand, fingertip, etc.) to which the stimulation output unit 20 is attached.

### 1-1-2. Sensing Movement of User

Further, the stimulation output unit 20 can include various sensors such as an acceleration sensor and a gyroscope. In this case, the stimulation output unit 20 is capable of sensing movement of the body (e.g., movement of hand, etc.) of the user to which the stimulation output unit 20 is attached. In addition, the stimulation output unit 20 is capable of transmitting a sensing result, as motion information of the user, to the information processing device 10 via the communication network 32.

### 1-2. HMD 30

The HMD 30 is, in one example, a head-mounted device having a display unit as illustrated in FIG. 1. The HMD 30 may be a light-shielding head-mounted display or may be a light-transmission head-mounted display. In one example, the HMD 30 can be an optical see-through device. In this case, the HMD 30 can have left-eye and right-eye lenses (or a goggle lens) and a display unit (not shown). Then, the display unit can project a picture using at least a partial area (or at least a partial area of a goggle lens) of each of the left-eye and right-eye lenses as a projection plane.

Alternatively, the HMD 30 can be a video see-through device. In this case, the HMD 30 can include a camera for capturing the front of the HMD 30 and a display unit (illustration omitted) for displaying the picture captured by the camera. In one example, the HMD 30 can sequentially display pictures captured by the camera on the display unit. This makes it possible for the user to view the scenery ahead of the user via the picture displayed on the display unit. Moreover, the display unit can be configured as, in one example, a liquid crystal display (LCD), an organic light emitting diode (OLED), or the like.

The HMD 30 is capable of displaying a picture or outputting sound depending on, in one example, the control information received from the information processing device 10. In one example, the HMD 30 displays the virtual object in accordance with the control information received from the information processing device 10. Further, the virtual object includes, in one example, 3D data generated by computer graphics (CG), 3D data obtained from a sensing result of a real object, or the like.

### 1-3. Information Processing Device 10

The information processing device 10 is an example of the information processing device according to the present disclosure. The information processing device 10 controls, in one example, the operation of the HMD 30 or the stimulation output unit 20 via a communication network 32 described later. In one example, the information processing device 10 causes the HMD 30 to display a picture relating to a virtual reality (VR) or augmented reality (AR). In addition, the information processing device 10 causes the stimulation output unit 20 to output predetermined tactile stimulation at a predetermined timing (e.g., at display of an image by the HMD 30, etc.).

Here, the information processing device 10 can be, in one example, a server, a general-purpose personal computer (PC), a tablet terminal, a game machine, a mobile phone such as smartphones, a portable music player, a robot, or the like. Moreover, although only one information processing device 10 is illustrated in FIG. 1, it is not limited to this example, and the function of the information processing device 10 according to the present embodiment may be implemented by a plurality of computers operating in cooperation.

### 1-4. Communication Network 32

The communication network 32 is a wired or wireless transmission channel of information transmitted from a device connected to the communication network 32. In one example, the communication network 32 may include a public network such as telephone network, the Internet, satellite communication network, various local area networks (LANs) including Ethernet (registered trademark), a wide area network (WAN), or the like. In addition, the communication network 32 may include a leased line network such as Internet protocol-virtual private network (IP-VPN).

### 1-5 Summary of Problems

The configuration of the information processing system according to the present embodiment is described above. Meanwhile, techniques for presenting desired skin sensation to a user have been studied. However, in the present circumstances, the range of skin sensation that can be presented is limited, and the extent of skin sensation that can be presented also varies with techniques.

In one example, when a user performs a motion to touch a virtual object displayed on the HMD 30, it is desirable that the stimulation output unit 20 is capable of outputting tactile stimulation (hereinafter, sometimes referred to as “target tactile stimulation”) corresponding to a target skin sensation determined in advance by, in one example, a producer in association with how the user touches the virtual object. However, the stimulation output unit 20 is sometimes likely to fail to output the target tactile stimulation, in one example, depending on the strength of the target tactile stimulation or the performance of the stimulation output unit 20.

Thus, considering the above circumstance as one point of view, the information processing device 10 according to the present embodiment is devised. The information processing device 10 acquires motion information of the user to the virtual object displayed on the HMD 30, and is capable of controlling display of an image including an onomatopoeic word (hereinafter referred to as onomatopoeic word image) depending on both the motion information and the virtual object. This makes it possible to present the user with the user's motion to the virtual object and visual information adapted to the virtual object.

Moreover, the onomatopoeic word is considered as an effective technique for presenting skin sensation as visual information, as is also used for, in one example, comics, novels, or the like. Here, the onomatopoeic word can include onomatopoeias (e.g., a character string expressing sound emitted by objects) and mimetic words (e.g., a character string expressing object's states and human emotions).

### 2. Detailed Description of Embodiment

### 2-1. Configuration

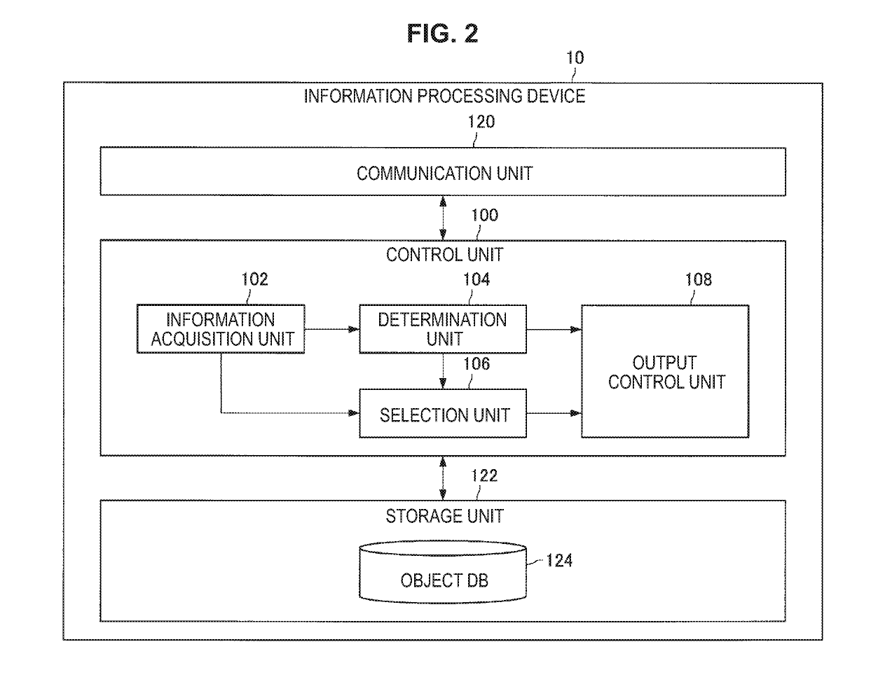

The configuration of the information processing device 10 according to the present embodiment is now described in detail. FIG. 2 is a functional block diagram illustrating a configuration example of the information processing device 10 according to the present embodiment. As illustrated in FIG. 2, the information processing device 10 includes a control unit 100, a communication unit 120, and a storage unit 122.

### 2-1-1. Control Unit 100

The control unit 100 may include, in one example, processing circuits such as a central processing unit (CPU) 150 described later or a graphic processing unit (GPU). The control unit 100 performs comprehensive control of the operation of the information processing device 10. In addition, as illustrated in FIG. 2, the control unit 100 includes an information acquisition unit 102, a determination unit 104, a selection unit 106, and an output control unit 108.

### 2-1-2. Information Acquisition Unit 102

### 2-1-2-1. Acquisition of Motion Information

The information acquisition unit 102 is an example of the acquisition unit in the present disclosure. The information acquisition unit 102 acquires motion information of the user wearing the stimulation output unit 20. In one example, in a case where the motion information is sensed by the stimulation output unit 20, the information acquisition unit 102 acquires the motion information received from the stimulation output unit 20. Alternatively, in a case of receiving a sensing result by another sensor (e.g., a camera or the like installed in the HMD 30) worn by the user wearing the stimulation output unit 20 or by still another sensor (such as camera) installed in the environment where the user is located, the information acquisition unit 102 may analyze (e.g., image recognition, etc.) the sensing result and then acquire an analysis result as the motion information of the user.

In one example, the information acquisition unit 102 acquires the motion information of the user to the virtual object in displaying the virtual object on the HMD 30 from the stimulation output unit 20. As an example, the information acquisition unit 102 acquires, as the motion information, a sensing result of movement in which the user touches the virtual object in displaying the virtual object on the HMD 30 from the stimulation output unit 20.

### 2-1-2-2. Acquisition of Attribute Information of Virtual Object

Further, the information acquisition unit 102 acquires attribute information of the virtual object displayed on the HMD 30. In one example, a producer determines attribute information for each virtual object in advance and then the virtual object and the attribute information can be registered in an object DB 124, which will be described later, in association with each other. In this case, the information acquisition unit 102 can acquire the attribute information of the virtual object displayed on the HMD 30 from the object DB 124.

Here, the attribute information can include, in one example, texture information (e.g., type of texture) associated with individual faces included in the virtual object. Moreover, texture information may be produced by the producer or may be specified on the basis of image recognition on an image in which a real object corresponding to the virtual object is captured. Here, the image recognition can be performed by using techniques such as machine learning or deep learning.

Object DB 124

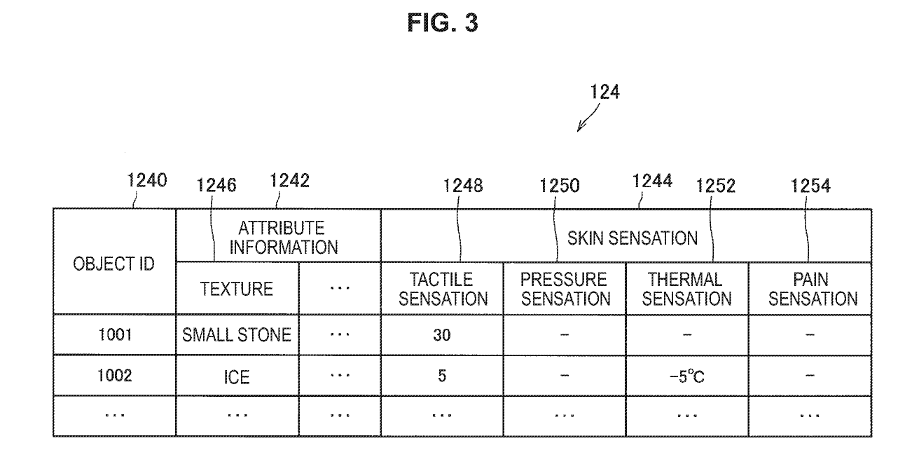

The object DB 124 is, in one example, a database that stores identification information and attribute information of the virtual object in association with each other. FIG. 3 is a diagram illustrated to describe a configuration example of the object DB 124. As illustrated in FIG. 3, the object DB 124 may have, in one example, an object ID 1240, an attribute information item 1242, and a skin sensation item 1244, which are associated with each other. In addition, the attribute information 1242 includes a texture item 1246. In addition, the skin sensation item 1244 includes, in one example, a tactile sensation item 1248, a pressure sensation item 1250, a thermal sensation item 1252, and a pain sensation item 1254. Here, the texture item 1246 has information (texture type, etc.) of text associated with the relevant virtual object, which is stored therein. In addition, the tactile sensation item 1248, the pressure sensation item 1250, the thermal sensation item 1252, and the pain sensation item 1254 respectively have a reference value of a parameter relating to tactile sensation, a reference value of a parameter relating to pressure sensation, a reference value of a parameter relating to thermal sensation, a reference value of a parameter relating to pain sensation, which are associated with their respective texture.

### 2-1-3. Determination Unit 104

### 2-1-3-1. Determination of Movement of User

The determination unit 104 determines the user's movement to the virtual object displayed on the HMD 30 on the basis of the motion information acquired by the information acquisition unit 102. In one example, the determination unit 104 determines whether or not the user touches the virtual object displayed on the HMD 30 (e.g., whether or not the user is touching) on the basis of the acquired motion information. Further, in a case where it is determined that the user touches the virtual object, the determination unit 104 further determines how the user touches the virtual object. Here, how the user touches includes, in one example, strength to touch, speed of touching, direction to touch, or the like.

### 2-1-3-2. Determination of Target Skin Sensation

Further, the determination unit 104 is capable of determining a target skin sensation further depending on how the user touches the virtual object. In one example, the information of texture and information of a target skin sensation (value of each sensation parameter, etc.) can be associated with each other and stored in a predetermined table. In this case, the determination unit 104 first can specify texture information of a face that the user is determined to touch among the faces included in the virtual object displayed on the HMD 30. Then, the determination unit 104 can specify information of the target skin sensation, on the basis of the texture information of the specified face, how the user touches the face, and the predetermined table. Moreover, the predetermined table may be the object DB 124.

Moreover, as a modification, the texture information and the target skin sensation information are not necessarily associated with each other. In this case, the information processing device 10 (the control unit 100) first may acquire, for each face included in the virtual object displayed on the HMD 30, sound data associated with the texture information of the face, and may dynamically generate the target skin sensation information on the basis of the acquired sound data and the known technique. Moreover, the respective pieces of texture information and sound data may be stored, in association with each other, in other device (not shown) connected to the communication network 32 or in the storage unit 122.

### 2-1-3-3. Determination of Presence or Absence of Reception Information or Transmission Information

Further, the determination unit 104 is also capable of determining the presence or absence of reception information from the stimulation output unit 20 or transmission information to the stimulation output unit 20 or the HMD 30. Here, the reception information includes, in one example, an output signal or the like outputted by the stimulation output unit 20. In addition, the transmission information includes, in one example, a feedback signal, or the like to the HMD 30.

### 2-1-3-4. Determination of Presence or Absence of Contact with Stimulation Output Unit 20

Further, the determination unit 104 is capable of determining whether or not the stimulation output unit 20 is in contact with the user (e.g., whether or not the stimulation output unit 20 is attached to the user, etc.) on the basis of, in one example, the presence or absence of reception from the stimulation output unit 20, data to be received (such as motion information), or the like. In one example, there may be a case where there is no reception from the stimulation output unit 20 for a predetermined time or longer, a case where the motion information received from the stimulation output unit 20 indicates that the stimulation output unit 20 is stationary, or other cases. In such case, the determination unit 104 determines that the stimulation output unit 20 is not in contact with the user.

### 2-1-4. Selection Unit 106

The selection unit 106 selects a display target onomatopoeic word depending on both the attribute information acquired by the information acquisition unit 102 and the determination result obtained by the determination unit 104.

### 2-1-4-1. Example 1 of Selection of Onomatopoeic Word

In one example, an onomatopoeic word can be preset for each virtual object by a producer, and the virtual object and the onomatopoeic word can be further registered in the object DB 124 in association with each other. In this case, the selection unit 106 can first extract an onomatopoeic word associated with a virtual object determined to be in contact with the user from among one or more virtual objects displayed by the HMD 30 from the object DB 124. Then, the selection unit 106 can select the extracted onomatopoeic word as the display target onomatopoeic word.

Alternatively, the onomatopoeic word may be preset for each texture by a producer, and the texture and onomatopoeic word can be associated with each other and registered in a predetermined table (not shown). In this case, the selection unit 106 can first extract the onomatopoeic word associated with the texture information of the face, which is determined to be in contact with the user, among the faces included in the virtual object displayed by the HMD 30 from the predetermined table. Then, the selection unit 106 can select the extracted onomatopoeic word as the display target onomatopoeic word.

### 2-1-4-2. Example 2 of Selection of Onomatopoeic Word

Alternatively, the selection unit 106 is also capable of selecting any one of a plurality of types of onomatopoeic words preregistered as the display target onomatopoeic word on the basis of the determination result obtained by the determination unit 104. Moreover, the plurality of types of onomatopoeic words may be stored in advance in the storage unit 122 or may be stored in another device connected to the communication network 32.

Selection Depending on Direction to Touch

In one example, the selection unit 106 is capable of selecting any one of the plurality of types of onomatopoeic words as the display target onomatopoeic word depending on both the direction of change in contact positions in determining that the user touches the virtual object and the relevant virtual object. As an example, the selection unit 106 selects any one of the plurality of types of onomatopoeic words as the display target onomatopoeic word depending on both a result obtained by determining the direction in which the user touches the virtual object and the relevant virtual object.

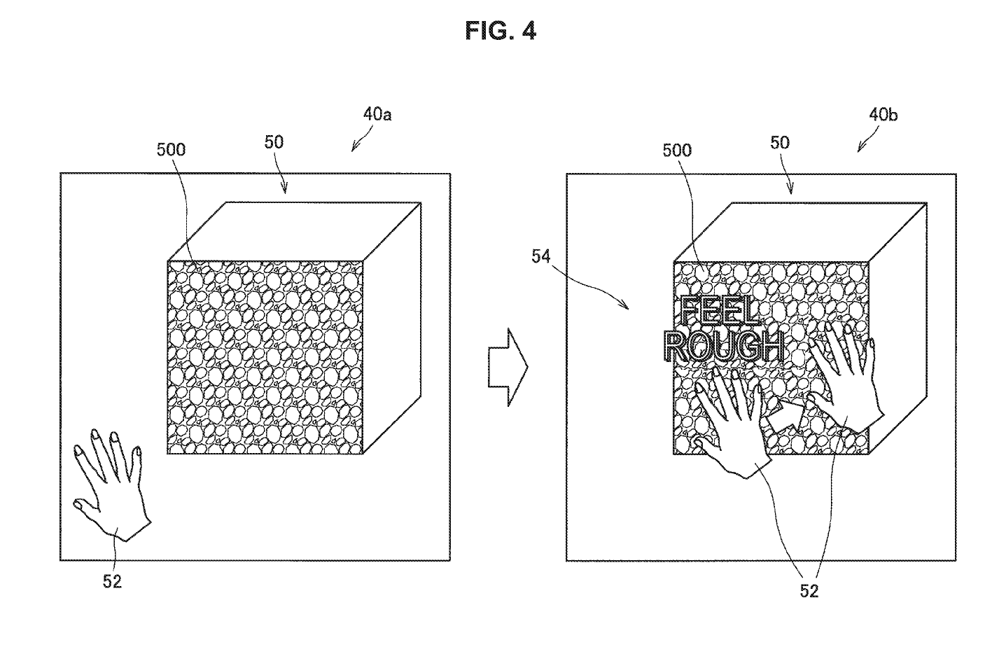

The functions described above are now described in more detail with reference to FIG. 4. FIG. 4 is a diagram illustrated to describe a display example of a frame image 40 including a virtual object 50 in the HMD 30. Moreover, in the example illustrated in FIG. 4, a face 500 included in the virtual object 50 is assumed to be associated with texture including a large number of small stones. In this case, as illustrated in FIG. 4, in a case of determining that the user performs a motion to touch the face 500 in the direction parallel to the face 500, the selection unit 106 selects an onomatopoeic word “feel rough” from among the plurality of types of onomatopoeic words as the display target onomatopoeic word, depending on both the texture associated with the face 500 and the determination result of the direction in which the user touches the face 500. Moreover, in the example illustrated in FIG. 4, in a case where it is determined that the user performs a motion to touch the face 500 in the vertical direction, the selection unit 106 can select an onomatopoeic word different from the type of “feel rough” as the display target onomatopoeic word.

Selection Depending on Speed of Touch

Further, the selection unit 106 is also capable of selecting any one of the plurality of types of onomatopoeic words as the display target onomatopoeic word depending on both the speed of change in contact positions in determining that the user touches the virtual object and the relevant virtual object. In one example, the selection unit 106 selects any one of the plurality of types of onomatopoeic words as the display target onomatopoeic word depending on both the determination result of the speed at which the user touches the virtual object and the relevant virtual object.

In one example, in a case where the speed at which the user touches the virtual object is higher than or equal to a predetermined speed, the selection unit 106 selects, as the display target onomatopoeic word, an onomatopoeic word different from the first onomatopoeic word that is selected in a case where the speed at which the user touches the virtual object is less than the predetermined speed. As an example, in a case where the speed at which the user touches the virtual object is higher than or equal to the predetermined speed, the selection unit 106 may select the abbreviated expression of the first onomatopoeic word and the emphasized expression of the first onomatopoeic word as the display target onomatopoeic word. Moreover, the emphasized expression of the first onomatopoeic word can include a character string obtained by adding a predetermined symbol (such as “!”) to the end part of the first onomatopoeic word.

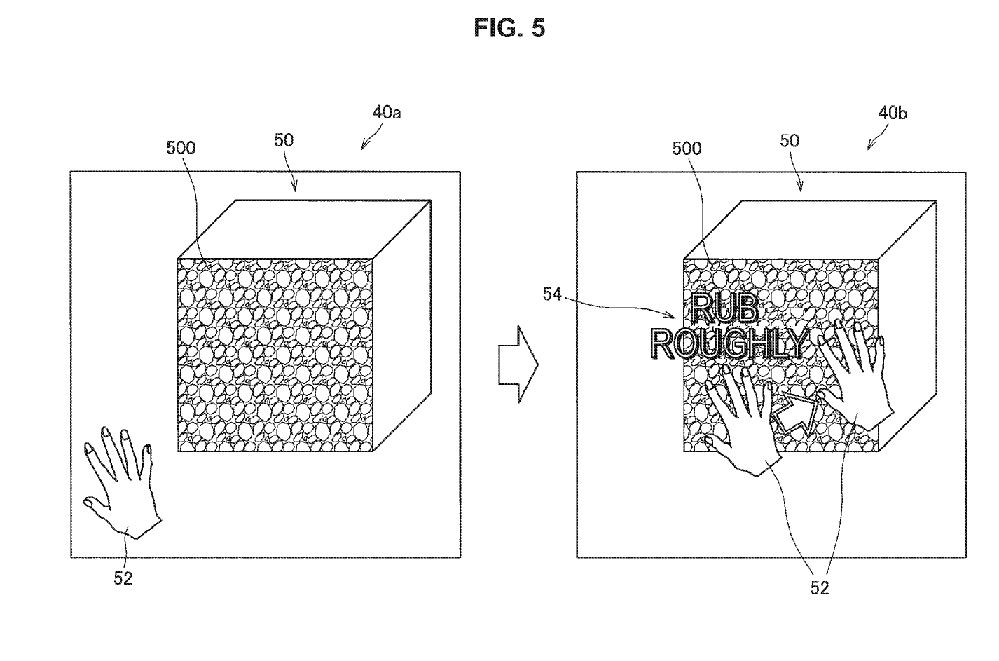

The functions described above are now described in more detail with reference to FIGS. 4 and 5. Moreover, the example illustrated in FIG. 4 is based on the assumption that the user is determined to touch the face 500 of the virtual object 50 at a speed less than a predetermined speed. In addition, the example illustrated in FIG. 5 is based on the assumption that the user is determined to perform a motion to touch the virtual object 50 at a speed higher than or equal to a predetermined speed. In this case, in the case where it is determined that the user touches the face 500 at a speed higher than or equal to the predetermined speed, as illustrated to FIG. 5, the selection unit 106 selects an onomatopoeic word (“rub roughly” in the example illustrated in FIG. 5) different from the onomatopoeic word (“feel rough”) as the display target onomatopoeic word.

Selection Depending on Strength to Touch

Further, the selection unit 106 is also capable of selecting any one of the plurality of types of onomatopoeic words as the display target onomatopoeic word depending on both the strength to touch when the user touches the virtual object and the relevant virtual object.

Selection Depending on Distance Between Virtual Object and User

Further, the selection unit 106 is also capable of selecting any one of the plurality of types of onomatopoeic words as the display target onomatopoeic word depending on both the distance between the virtual object and the user and the relevant virtual object. In one example, in a case where the virtual object is an animal (such as a dog) having many hairs and the user touches only the tip portions of the hair (i.e., case where the distance between the animal and the user's hand is large), the selection unit 106 selects an onomatopoeic word of “smooth and dry” from among the plurality of types of onomatopoeic words as the display target onomatopoeic word. In addition, in a case where the user touches the skin of the animal (i.e., case where the distance between the animal and the user's hand is small), the selection unit 106 selects an onomatopoeic word of “shaggy” from among the plurality of types of onomatopoeic words as the display target onomatopoeic word.

Selection Depending on Target Skin Sensation

Further, in determining that the user touches the virtual object by the determination unit 104, the selection unit 106 is also capable of selecting any one of the plurality of types of onomatopoeic words as the display target onomatopoeic word on the basis of information of the target skin sensation determined by the determination unit 104. In one example, the selection unit 106 first estimates each of the plurality of types of onomatopoeic words on the basis of values of four types of parameters included in the information of the target skin sensation determined by the determination unit 104 (i.e., tactile parameter value, pressure sensation parameter value, thermal sensation parameter value, and pain sensation parameter value). Then, the selection unit 106 specifies an onomatopoeic word having the highest evaluation value and selects the specified onomatopoeic word as the display target onomatopoeic word.

Selection Depending on Users

Further, the selection unit 106 is also capable of selecting any one of the plurality of types of onomatopoeic words as the display target onomatopoeic word further depending on the profile of the user wearing the HMD 30. Here, the profile may include, in one example, age, sex, language (such as mother tongue), or the like.

In one example, the selection unit 106 selects any one of onomatopoeic words in the language used by the user, which is included in the plurality of types of onomatopoeic words, as the display target onomatopoeic word on the basis of the determination result of movement in which the user touches the virtual object. In addition, the selection unit 106 selects any one of the plurality of types of onomatopoeic words as the display target onomatopoeic word depending on both the determination result of movement in which the user touches the virtual object and the user's age or sex. In one example, in a case where the user is a child, the selection unit 106 first specifies a plurality of types of onomatopoeic words depending on the determination result of movement in which the user touches the virtual object, and selects an onomatopoeic word having a simpler expression (e.g., onomatopoeic word to be used by child, etc.) as the display target onomatopoeic word from among the specified onomatopoeic words.

### 2-1-5. Output Control Unit 108

The output control unit 108 controls display of an image by the HMD 30. In one example, the output control unit 108 causes the communication unit 120 to transmit display control information used to cause the HMD 30 to display a virtual object. In addition, the output control unit 108 controls output of tactile stimulation to the stimulation output unit 20. In one example, the output control unit 108 causes the communication unit 120 to transmit output control information used to cause the stimulation output unit 20 to output tactile stimulation.

### 2-1-5-1. Determination of Display of Onomatopoeic Word Image

In one example, the output control unit 108 causes the HMD 30 to display an onomatopoeic word image on the basis of the determination result obtained by the determination unit 104. As an example, in a case where the determination unit 104 determines that the user touches the virtual object, the output control unit 108 causes the HMD 30 to display an onomatopoeic word image including the onomatopoeic word selected by the selection unit 106 in one example as illustrated in FIG. 4 in the vicinity of a position at which the user is determined to touch the virtual object.

More specifically, the output control unit 108 causes the HMD 30 to display the onomatopoeic word image depending on both the determination result as to whether or not the stimulation output unit 20 is attached to the user and the determination result as to whether or not the user touches the virtual object displayed on the HMD 30. In one example, in a case where it is determined that the user touches the virtual object while determining that the stimulation output unit 20 is not attached to the user, the output control unit 108 causes the HMD 30 to display the onomatopoeic word image.

Further, in a case where it is determined that the user touches the virtual object while determining that the stimulation output unit 20 is attached to the user, the output control unit 108 determines whether or not to cause the HMD 30 to display the onomatopoeic image on the basis of the information of tactile stimulation corresponding to the target skin sensation determined by the determination unit 104 and the information relating to tactile stimulation that can be outputted by the stimulation output unit 20. In one example, in a case where it is determined that the stimulation output unit 20 is capable of outputting the target tactile stimulation, the output control unit 108 causes the stimulation output unit 20 to output the target tactile stimulation and determines to cause the HMD 30 not to display the target onomatopoeic word image. Alternatively, in a case where it is determined that the stimulation output unit 20 is capable of outputting the target tactile stimulation, the output control unit 108 may change (increase or decrease) the visibility of the onomatopoeic image depending on the amount of tactile stimulation to be outputted by the stimulation output unit 20. Examples of parameters relating to the visibility include various parameters such as display size, display time period, color, luminance, transparency, and the like. In addition, in a case where the shape of an onomatopoeic word is dynamically changed, the output control unit 108 may increase the operation amount of an onomatopoeic word as a parameter relating to visibility. In addition, the output control unit 108 may change the shape statically to increase the visibility or add additional effects other than onomatopoeic words. An example of static shape change includes a change in fonts. Such change in factors relating to visibility may be combined with two or more as appropriate. Moreover, in a case where the amount of tactile stimulation increases (or decreases), the output control unit 108 may increase (or decrease) the visibility of onomatopoeic word to emphasize the feedback. In a case where the amount of tactile stimulation increases (decreases), the output control unit 108 may reduce (or increase) the visibility of onomatopoeic words to keep a balance of the feedback. In addition, the relationship between the amount of tactile stimulation and the change in visibility may be set to be proportional or inversely proportional, or the tactile stimulation and the visibility may be associated with each other in a stepwise manner.

Further, in a case where it is determined that the stimulation output unit 20 is incapable of outputting the target tactile stimulation, the output control unit 108 causes the stimulation output unit 20 to output tactile stimulation that is closest to the target tactile stimulation within a range that can be outputted by the stimulation output unit 20 and determines to cause the HMD 30 to display the onomatopoeic word image. Moreover, a limit value of the performance of the stimulation output unit 20 may be set as the upper limit value or the lower limit value of the range that can be outputted by the stimulation output unit 20, or alternatively, the user may optionally set the upper limit value or the lower limit value. Moreover, the upper limit value that can be optionally set can be smaller than the limit value (upper limit value) of the performance of the stimulation output unit 20. In addition, the lower limit value that can be optionally set can be larger than the limit value (lower limit value) of the performance.

### 2-1-5-2. Change in Display Modes of Onomatopoeic Word Image

Modification 1

Further, the output control unit 108 is capable of dynamically changing the display mode of the onomatopoeic word image on the basis of a predetermined criterion. In one example, the output control unit 108 may change the display mode of the onomatopoeic word image depending on the direction of change in contact positions in determining that the user touches the virtual object displayed on the HMD 30. As an example, the output control unit 108 may change the display mode of the onomatopoeic word image depending on the determination result of the direction in which the user touches the virtual object.

Modification 2

Further, the output control unit 108 may change the display mode of the onomatopoeic word image depending on the speed at which the user touches in determining that the user touches the virtual object displayed on the HMD 30. In one example, the output control unit 108 may decrease the length of the display time of the onomatopoeic word image, as the speed at which the user touches in determining that the user touches the virtual object is higher. In addition, in one example, in a case where the onomatopoeic word image is a moving image or the like, the output control unit 108 may increase the display speed of the onomatopoeic word image, as the speed at which the user touches in determining that the user touches the virtual object is higher.

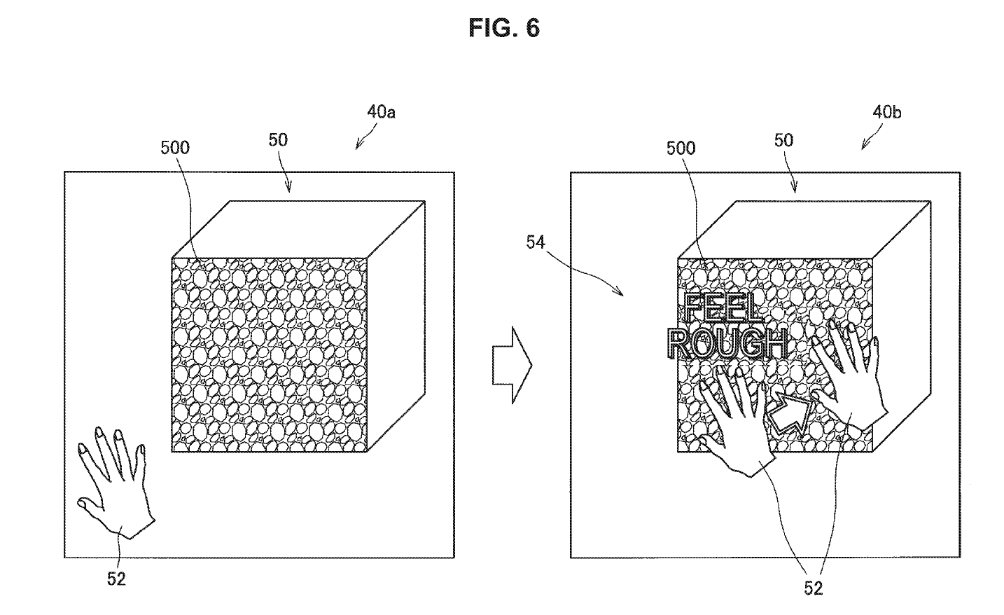

Alternatively, the output control unit 108 may increase the display size of the onomatopoeic word image, as the speed at which the user touches in determining that the user touches the virtual object is higher. FIG. 6 is a diagram illustrated to describe an example in which the same virtual object 50 as the example illustrated in FIG. 4 is displayed on the HMD 30 and the user touches the virtual object 50 at a higher speed than the example illustrated in FIG. 4. As illustrated in FIGS. 4 and 6, the output control unit 108 may increase the display size of the onomatopoeic word image, as the speed at which the user touches in determining that the user touches the virtual object 50 is higher.

Further, the output control unit 108 may change a display frequency of the onomatopoeic word image depending on the determination result of how the user touches the virtual object. These control examples make it possible to present the skin sensation when the user touches the virtual object more emphatically.

Further, the output control unit 108 may change the display mode (e.g., character font, etc.) of the onomatopoeic word image depending on the profile of the user.

### 2-1-5-3. Example of Other Display than Onomatopoeic Word

Moreover, although the above description is given of the example in which the output control unit 108 causes the HMD 30 to display the onomatopoeic word image depending on the user's motion to the virtual object, but this is not limited to such an example. In one example, the output control unit 108 may cause the HMD 30 to display the display effect (instead of the onomatopoeic word image) depending on the user's motion to the virtual object. As an example, in a case where it is determined that the user touches the virtual object displayed on the HMD 30, the output control unit 108 may cause the HMD 30 to display the virtual object by adding the display effect to it.

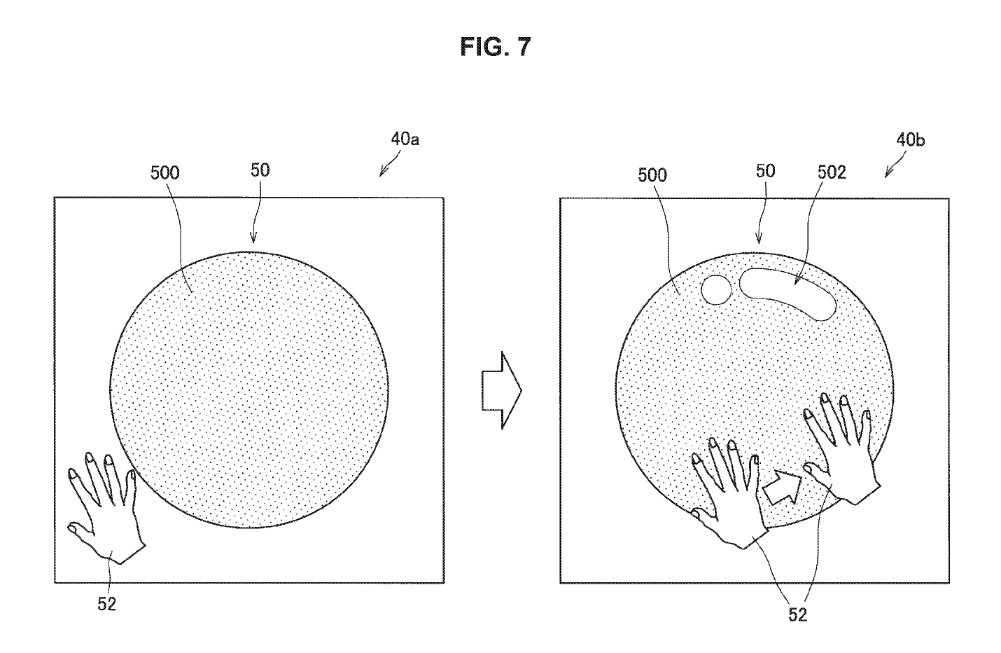

The functions described above are now described in more detail with reference to FIG. 7. In one example, the assumption is given that it is determined that the user touches the face 500 included in the virtual object 50 in a situation where the virtual object 50 is displayed on the HMD 30 like a frame image 40a illustrated in FIG. 7. In this case, the output control unit 108 may cause the HMD 30 to display the virtual object 50 by adding a gloss representation 502 to it, like a frame image 40b illustrated in FIG. 7.

### 2-1-6. Communication Unit 120

The communication unit 120 can be configured to include, in one example, a communication device 162 to be described later. The communication unit 120 transmits and receives information to and from other devices. In one example, the communication unit 120 receives the motion information from the stimulation output unit 20. In addition, the communication unit 120 transmits the display control information to the HMD 30 and transmits the output control information to the stimulation output unit 20 under the control of the output control unit 108.

### 2-1-7. Storage Unit 122

The storage unit 122 can be configured to include, in one example, a storage device 160 to be described later. The storage unit 122 stores various types of data and various types of software. In one example, as illustrated in FIG. 2, the storage unit 122 stores the object DB 124.

Moreover, the configuration of the information processing device 10 according to the present embodiment is not limited to the example described above. In one example, the object DB 124 may be stored in other device (not shown) connected to the communication network 32 instead of being stored in the storage unit 122.

### 2-2. Processing Procedure

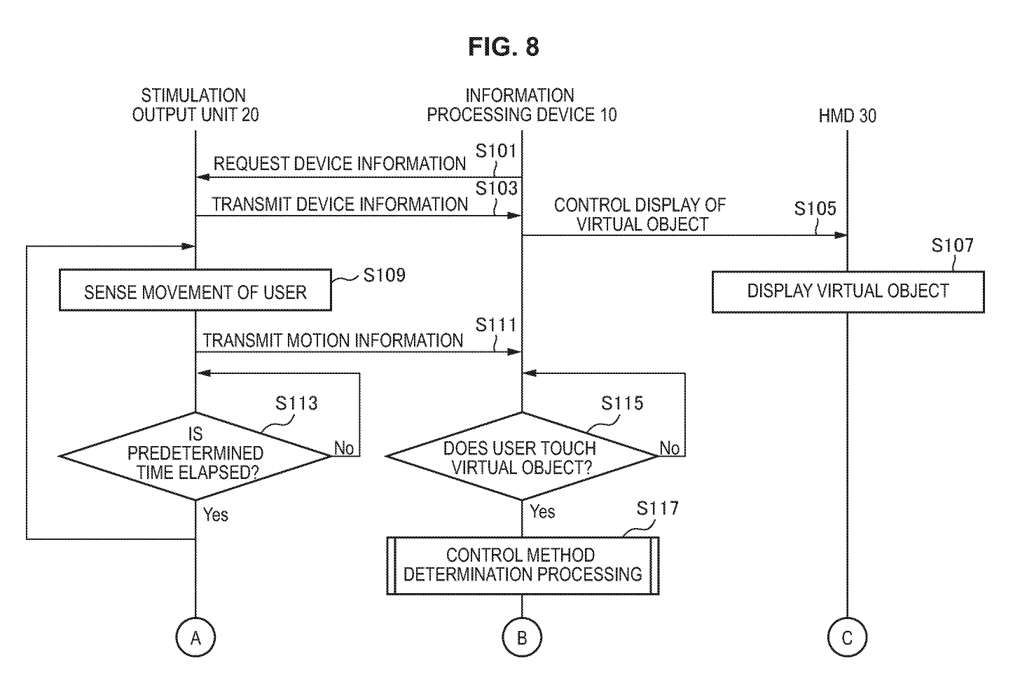

The configuration of the present embodiment is described above. Then, an example of a processing procedure according to the present embodiment is described with reference to FIGS. 8 to 10. Moreover, the following description is given of an example of the processing procedure in a situation where the information processing device 10 causes the HMD 30 to display the image including the virtual object. In addition, here, it is assumed that the user wears the stimulation output unit 20.

### 2-2-1. Overall Processing Procedure

As illustrated in FIG. 8, first, the communication unit 120 of the information processing device 10 transmits a request to acquire device information (such as device ID) to the stimulation output unit 20 attached to the user under the control of the control unit 100 (S101). Then, upon receiving the acquisition request, the stimulation output unit 20 transmits the device information to the information processing device 10 (S103).

Subsequently, the output control unit 108 of the information processing device 10 transmits display control information used to cause the HMD 30 to display a predetermined image including the virtual object to the HMD 30 (S105). Then, the HMD 30 displays the predetermined image in accordance with the display control information (S107).

Subsequently, the stimulation output unit 20 senses the user's movement (S109). Then, the stimulation output unit 20 transmits the sensing result as motion information to the information processing device 10 (S111). Subsequently, after lapse of predetermined time (Yes in S113), the stimulation output unit 20 performs the processing of S109 again.

Further, upon receiving the motion information in S111, the determination unit 104 of the information processing device 10 determines whether or not the user touches the virtual object displayed on the HMD 30 on the basis of the motion information (S115). If it is determined that the user does not touch the virtual object (No in S115), the determination unit 104 waits until motion information is newly received, and then performs the processing of S115 again.

On the other hand, if it is determined that the user touches the virtual object (Yes in S115), the information processing device 10 performs a “control method determination processing” to be described later (S117).

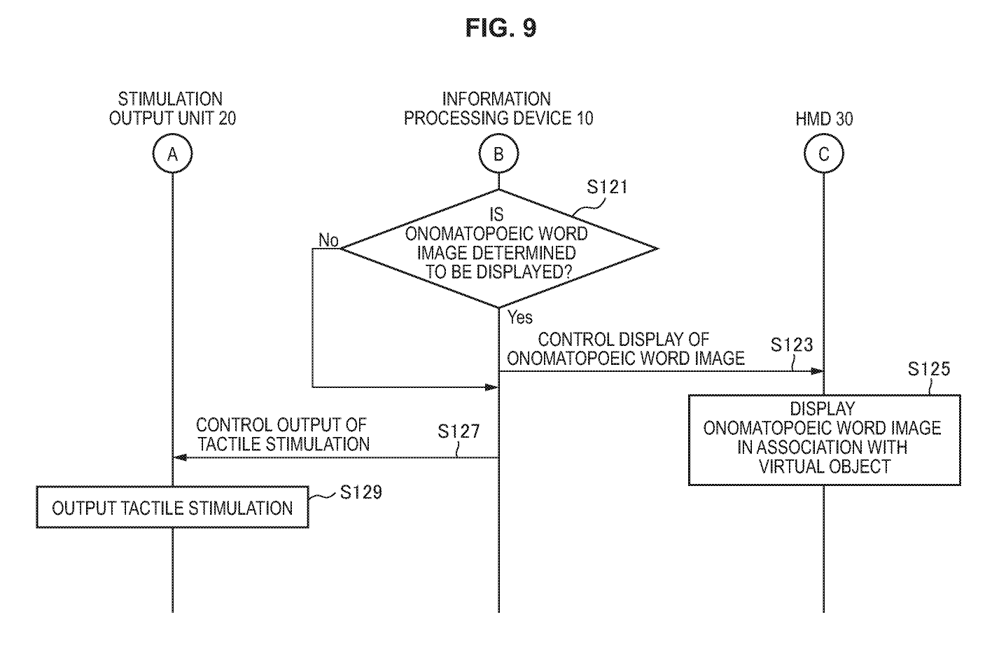

The processing procedure after S117 is now described with reference to FIG. 9. As illustrated in FIG. 9, in a case where it is determined in S117 that the onomatopoeic word image is displayed on the HMD 30 (Yes in S121), the communication unit 120 of the information processing device 10 transmits the display control information generated in S117 to the HMD 30 under the control of the output control unit 108 (S123). Then, the HMD 30 displays the onomatopoeic word image in association with the virtual object being displayed in accordance with the received display control information (S125).

Further, if it is determined in S117 that the HMD 30 is not caused to display the onomatopoeic word image (No in S121) or after S123, the communication unit 120 of the information processing device 10 transmits the output control information generated in S117 to the stimulation output unit 20 under the control of the output control unit 108 (S127). Then, the stimulation output unit 20 outputs the tactile stimulation in accordance with the received output control information (S129).

### 2-2-2. Control Method Determination Processing

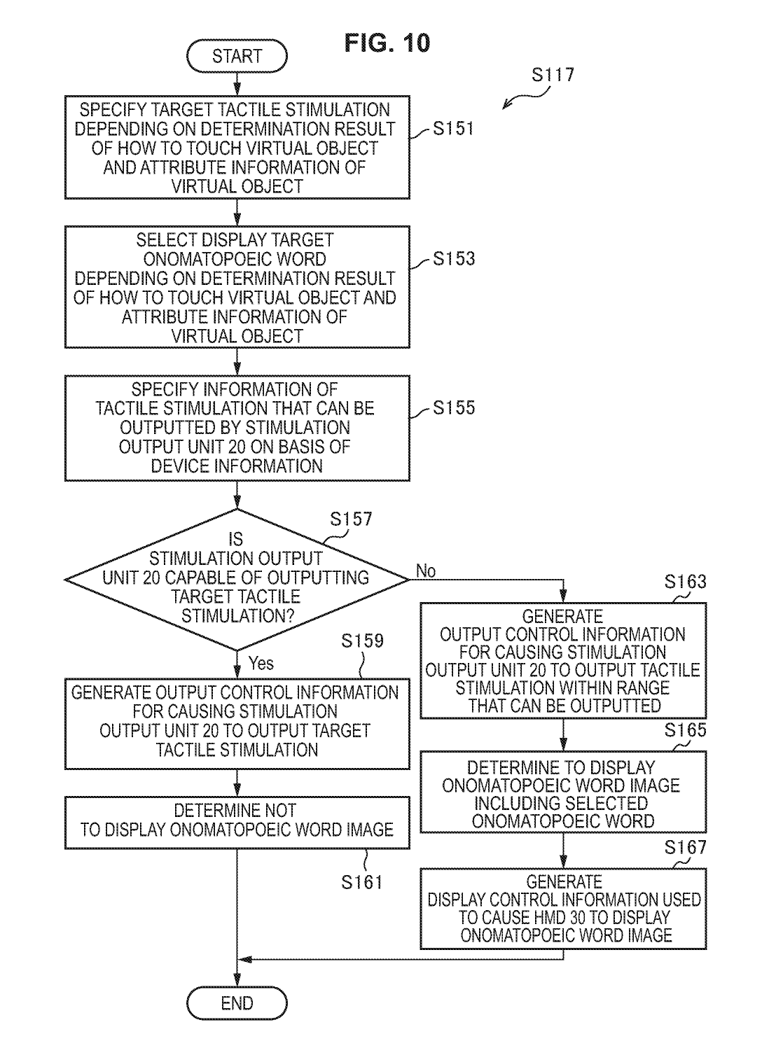

The procedure of “control method determination processing” in S117 is now described in more detail with reference to FIG. 10. As illustrated in FIG. 10, first, the information acquisition unit 102 of the information processing device 10 acquires attribute information associated with a virtual object that is determined to be touched by the user among one or more virtual objects displayed on the HMD 30. Then, the determination unit 104 specifies a target skin sensation depending on both how the user touches the virtual object and the attribute information of the virtual object determined in S115, and specifies information of the tactile stimulation corresponding to the target skin sensation (S151).

Subsequently, the selection unit 106 selects a display target onomatopoeic word depending on both the determination result of how the user touches the virtual object and the attribute information of the virtual object (S153).

Subsequently, the output control unit 108 specifies the information of the tactile stimulation that can be outputted by the stimulation output unit 20 on the basis of the device information received in S103 (S155).

Subsequently, the output control unit 108 determines whether or not the stimulation output unit 20 is capable of outputting the target tactile stimulation specified in S151 on the basis of the information specified in S155 (S157). If it is determined that the stimulation output unit 20 is capable of outputting the target tactile stimulation (Yes in S157), the output control unit 108 generates output control information used to cause the stimulation output unit 20 to output the information of target tactile stimulation (S159). Then, the output control unit 108 determines to cause the HMD 30 not to display the onomatopoeic word image (S161). Then, the “control method determination processing” is terminated.

On the other hand, if it is determined that the stimulation output unit 20 is incapable of outputting the target tactile stimulation (No in S157), the output control unit 108 generates output control information used to cause the stimulation output unit 20 to output tactile stimulation closest to the target tactile stimulation within a range that can be outputted by the stimulation output unit 20 (S163).

Subsequently, the output control unit 108 determines to cause the HMD 30 to display the onomatopoeic word image including the onomatopoeic word selected in S153 (S165). Then, the output control unit 108 generates display control information used to cause the HMD 30 to display the onomatopoeic word image (S167). Then, the “control method determination processing” is terminated.

### 2-3. Advantageous Effect

According to the present embodiment as described above, the information processing device 10 acquires motion information of the user to the virtual object displayed on the HMD 30 and controls display of the onomatopoeic word image depending on both the motion information and the virtual object. This makes it possible to present the user with the visual information adapted to the user's motion to the virtual object and the relevant virtual object.

In one example, in determining that the user touches the virtual object, the information processing device 10 does not cause the HMD 30 to display the onomatopoeic word image in a case where the stimulation output unit 20 is capable of outputting the target tactile stimulation corresponding to the determination result of how the user touches and the virtual object. Further, in a case where the stimulation output unit 20 is incapable of outputting the target tactile stimulation, the information processing device 10 causes the HMD 30 to display the onomatopoeic word image. Thus, in a case where the stimulation output unit 20 is incapable of outputting the target tactile stimulation (i.e., tactile stimulation corresponding to the target skin sensation), the information processing device 10 is capable of compensating for presentation of the target skin sensation to the user by using visual information such as the onomatopoeic word image or the like. Thus, it is possible to adequately present the target skin sensation to the user.

### 2-4. Application Example

The present embodiment is described above. Meanwhile, in a case where a certain user touches a real object or a virtual object, it is also desired that other users other than the certain user described above are able to recognize the skin sensation given to the user.

### 2-4-1. Overview

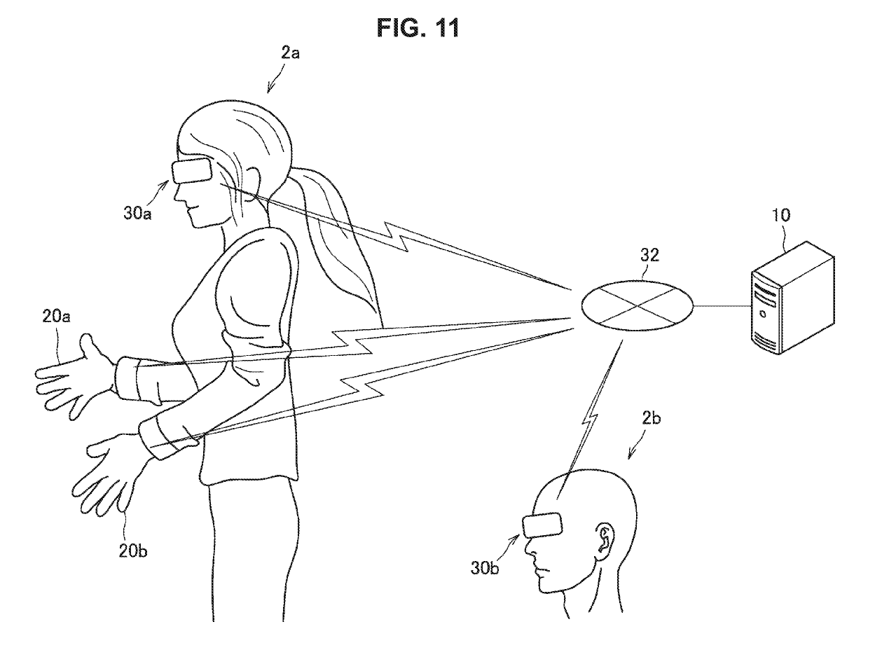

An application example of the present embodiment is now described. FIG. 11 is a diagram illustrated to describe a configuration example of an information processing system according to the present application example. As illustrated in FIG. 11, in the present application example, a user 2a is wearing a stimulation output unit 20 and an HMD 30a, and another user 2b can wear an HMD 30b. Then, a picture including a virtual object can be displayed on the HMD 30a and the HMD 30b. Here, the user 2b may be located near the user 2a or may be located at a remote place from a place where the user 2a is located. Moreover, other contents are similar to those of the information processing system illustrated in FIG. 1, and so the description thereof will be omitted.

### 2-4-2. Configuration

The configuration according to the present application example now is described. Moreover, the description of components having functions similar to those of the above-described embodiment will be omitted.

### (Output Control Unit 108)

The output control unit 108 according to the present application example is capable of controlling display of the onomatopoeic word image depending on both the determination result of how the user 2a touches the virtual object and whether or not the other user 2b views the picture of the virtual object.

### Display Example 1

In one example, in a case where the other user 2b is viewing the picture of the virtual object, the output control unit 108 causes both the HMD 30a attached to the user 2a and the HMD 30b attached to the user 2b to display the onomatopoeic word image corresponding to how the one user 2a touches the virtual object. As an example, in this case, the output control unit 108 causes the both HMDs 30 to display the onomatopoeic word images, which correspond to how the user 2a touches the virtual object, in a vicinity of the place where the user 2a touches the virtual object. In addition, in a case where the other user 2b is not viewing the picture of the virtual object (e.g., case where the user 2b is not wearing the HMD 30b, etc.), no onomatopoeic word image is caused to be displayed on any of the HMDs 30. According to this display example, the user 2b is able to recognize visually the skin sensation when the user 2a touches the virtual object. In addition, the user 2a is able to recognize whether or not the user 2b is viewing the picture of the virtual object.

### Display Example 2

Alternatively, if the other user 2b is not viewing the picture of the virtual object, the output control unit 108 may cause the HMD 30a (attached to the user 2a) to display the onomatopoeic word image without rotating the onomatopoeic word image. In addition, in the case where the user 2b is viewing the picture of the virtual object, the output control unit 108 may cause both the HMD 30a attached to the user 2a and the HMD 30b attached to the user 2b to display the onomatopoeic word image by rotating it.

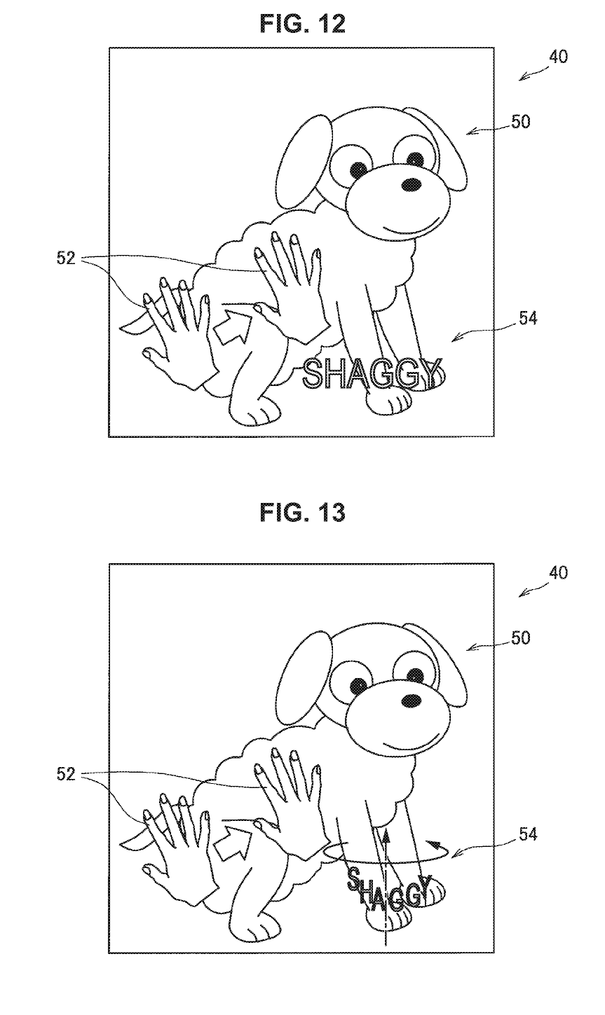

The functions described above are now described in more detail with reference to FIGS. 12 and 13. FIGS. 12 and 13 are diagrams illustrated to describe a situation in which the user 2a wearing the stimulation output unit 20 touches the virtual object 50 of an animal. In one example, if the other user 2b is not viewing the picture of the virtual object 50, the output control unit 108 causes only the HMD 30a to display an onomatopoeic word image 54 (including the onomatopoeic word “shaggy”) without rotating it as illustrated in FIG. 12. In addition, in the case where the other user 2b is viewing the picture of the virtual object 50, the output control unit 108 causes both the HMD 30a and the HMD 30b to display the onomatopoeic word image 54 by rotating it around the predetermined rotation axis A, in one example as illustrated in FIG. 13. According to this display example, the user 2a is able to recognize whether or not the other user 2b is viewing the picture of the virtual object 50.

### Display Example 3

Further, in one example, when the picture including the virtual object is a free viewpoint picture or the like, the output control unit 108 may change the display mode of an image in an area currently displayed on the HMD 30b attached to the other user 2b among images displayed on the HMD 30a attached to the user 2a. In one example, the output control unit 108 may display semi-transparently an image in the area currently displayed on the HMD 30b among images displayed on the HMD 30a. According to this display example, the user 2a is able to recognize whether or not the other user 2b is viewing the onomatopoeic word image in displaying the onomatopoeic word image on the HMD 30a.

### 2-4-3. Advantageous Effect

According to the present application example as described above, it is possible for the other user 2b to recognize, through the onomatopoeic word image, the skin sensation that can be presented to the user 2a by the stimulation output unit 20 when the user 2a wearing the stimulation output unit 20 touches the virtual object.

### 2-4-4. Usage Example

A usage example of the present application example is now described. In this usage example, it is assumed that the HMDs 30 attached to a plurality of users located at remote locations display images inside the same virtual space. This makes it possible for the plurality of users to experience as if they are in the virtual space. Alternatively, the information processing device 10 according to the present usage example may cause the light-transmission HMD 30 attached to the user 2a to display the image by superimposing the picture of the other user 2b located at a remote place on the real space in which the user 2a is located. This makes it possible for the user 2a to experience as if the user 2b is in the real space where the user 2a is located.

In one example, in a family where the father is transferred to a single location, in a case where a family member (e.g., a child) of the father is wearing, in one example, an optical see-through HMD 30a, the HMD 30a is capable of superimposing and displaying the picture of the father in the house (i.e., the child's house) in which the child lives. This makes it possible for the child to experience as if the child's father is at home together.

In this case, the information processing device 10 is capable of causing the HMD 30 to display the onomatopoeic word image on the basis of the determination result of the user's movement to an object present at the house, which is displayed on the HMD 30. In one example, in the information processing device 10 may select a display target onomatopoeic word depending on both how to touch when the father touches an object existing at home (e.g., a case where a switch for operating the device is pressed) and the relevant object, and then may cause the HMD 30 attached to the father to display the onomatopoeic word image including the selected onomatopoeic word. In addition, the information processing device 10 may select a display target onomatopoeic word depending on both how to touch when a child touches an object existing at home and the relevant object, and may cause the HMD 30 attached to the father to display the onomatopoeic word image including the selected onomatopoeic word.

According to this usage example, even in the case where the father is located at a remote place, it is possible to present visually the skin sensation obtained when a father or a child touches an object in their house to the father.

### 3. Hardware Configuration

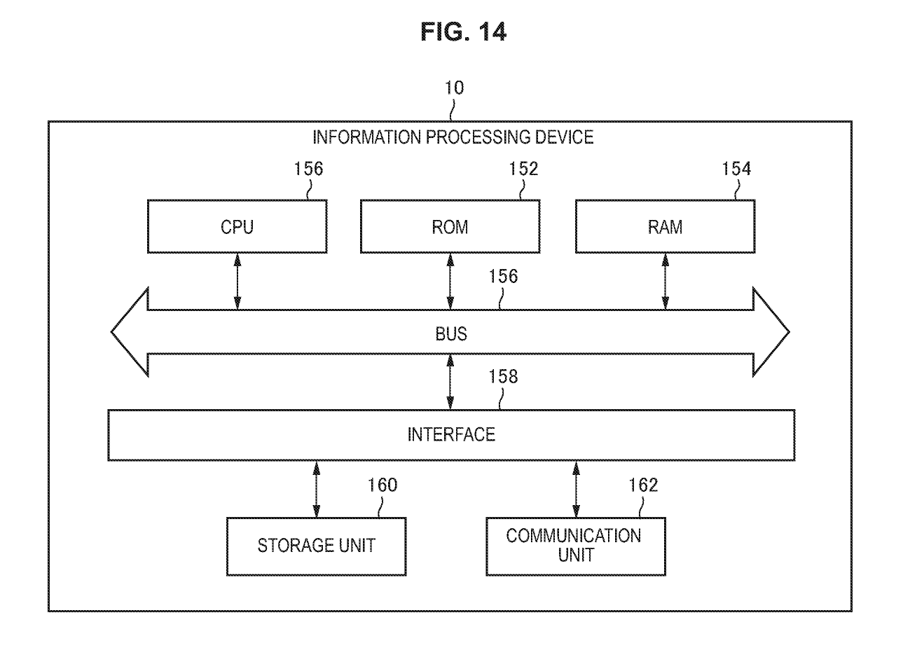

Next, with reference to FIG. 14, a hardware configuration of the information processing device 10 according to the embodiment will be described. As illustrated in FIG. 14, the information processing device 10 includes a CPU 150, read only memory (ROM) 152, random access memory (RAM) 154, a bus 156, an interface 158, a storage device 160, and a communication device 162.

The CPU 150 functions as an arithmetic processing device and a control device to control all operation in the information processing device 10 in accordance with various kinds of programs. In addition, the CPU 150 realizes the function of the control unit 100 in the information processing device 10. Note that, the CPU 150 is implemented by a processor such as a microprocessor.

The ROM 152 stores control data such as programs and operation parameters used by the CPU 150.

The RAM 154 temporarily stores programs executed by the CPU 150, data used by the CPU 150, and the like, for example.

The bus 156 is implemented by a CPU bus or the like. The bus 156 mutually connects the CPU 150, the ROM 152, and the RAM 154.

The interface 158 connects the storage device 160 and the communication device 162 with the bus 156.

The storage device 160 is a data storage device that functions as the storage unit 122. For example, the storage device 160 may include a storage medium, a recording device which records data in the storage medium, a reader device which reads data from the storage medium, a deletion device which deletes data recorded in the storage medium, and the like.

For example, the communication device 162 is a communication interface implemented by a communication device for connecting with the communication network 32 or the like (such as a network card). In addition, the communication device 162 may be a wireless LAN compatible communication device, a long term evolution (LTE) compatible communication device, or may be a wired communication device that performs wired communication. The communication device 162 functions as the communication unit 120.

### 4. Modifications

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

### 4-1. Modification 1

In one example, the configuration of the information processing system according to the above-described embodiment is not limited to the example illustrated in FIG. 1. As an example, the HMD 30 and the information processing device 10 may be integrally configured. In one example, each component included in the control unit 100 described above may be included in the HMD 30. In this case, the HMD 30 can control output of the tactile stimulation to the stimulation output unit 20.

Further, a projector may be arranged in the real space where the user 2 is located. Then, the information processing device 10 may cause the projector to project a picture including a virtual object or the like on a projection target (e.g., a wall, etc.) in the real space. In the present modification, the display unit in the present disclosure may be a projector. In addition, in this case, the information processing system may not necessarily have the HMD 30.

### 4-2. Modification 2

In addition, it is not necessary to execute the steps in the above described process according to the embodiment on the basis of the order described above. For example, the steps may be performed in a different order as necessary. In addition, the steps do not have to be performed chronologically but may be performed in parallel or individually. In addition, it is possible to omit some steps described above or it is possible to add another step.

In addition, according to the above described embodiment, it is also possible to provide a computer program for causing hardware such as the CPU 150, ROM 152, and RAM 154, to execute functions equivalent to the structural elements of the information processing device 10 according to the above described embodiment. Moreover, it may be possible to provide a recording medium having the computer program stored therein.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An information processing device including:

an acquisition unit configured to acquire motion information of a user with respect to a virtual object displayed by a display unit; and

an output control unit configured to control display of an image including an onomatopoeic word depending on the motion information and the virtual object.

(2)

The information processing device according to (1),

in which the acquisition unit further acquires attribute information associated with the virtual object, and the output control unit controls display of the image including the onomatopoeic word depending on the motion information and the attribute information.

(3)

The information processing device according to (2), further including:

a determination unit configured to determine whether or not the user touches the virtual object on the basis of the motion information,

in which the output control unit causes the display unit to display the image including the onomatopoeic word in a case where the determination unit determines that the user touches the virtual object.

(4)

The information processing device according to (3),

in which the output control unit changes a display mode of the image including the onomatopoeic word depending on a direction of change in contact positions in determining that the user touches the virtual object.

(5)

The information processing device according to (3) or (4),

in which the output control unit changes a display mode of the image including the onomatopoeic word depending on a speed of change in contact positions in determining that the user touches the virtual object.

(6)

The information processing device according to (5),

in which the output control unit makes a display time period of the image including the onomatopoeic word smaller as the speed of change in contact positions in determining that the user touches the virtual object is higher.

(7)

The information processing device according to (5) or (6),

in which the output control unit makes a display size of the image including the onomatopoeic word larger as the speed of change in contact positions in determining that the user touches the virtual object is higher.

(8)

The information processing device according to any one of (3) to (7), further including:

a selection unit configured to select any one of a plurality of types of onomatopoeic words depending on the attribute information,

in which the output control unit causes the display unit to display an image including an onomatopoeic word selected by the selection unit.

(9)

The information processing device according to (8),

in which the selection unit selects any one of the plurality of types of onomatopoeic words further depending on a direction of change in contact positions in determining that the user touches the virtual object.

(10)

The information processing device according to (8) or (9),

in which the selection unit selects any one of the plurality of types of onomatopoeic words further depending on a speed of change in contact positions in determining that the user touches the virtual object.

(11)

The information processing device according to any one of (8) to (10),

in which the selection unit further selects any one of the plurality of types of onomatopoeic words further depending on a profile of the user.

(12)

The information processing device according to any one of (3) to (11),

in which the output control unit causes a stimulation output unit to output stimulation relating to a tactile sensation further depending on the motion information and the attribute information in the case where the determination unit determines that the user touches the virtual object.

(13)

The information processing device according to (12),

in which the determination unit further determines presence or absence of reception information or transmission information of the stimulation output unit, and the output control unit causes the display unit to display the image including the onomatopoeic word in a case of determining that there is no reception information or transmission information and the user touches the virtual object.

(14)

The information processing device according to (12) or (13),

in which the determination unit further determines presence or absence of reception information or transmission information of the stimulation output unit, and

the output control unit causes the display unit to display the image including the onomatopoeic word on the basis of target tactile stimulation corresponding to how the user touches the virtual object and information relating to tactile stimulation that can be outputted by the stimulation output unit in a case of determining that there is the reception information or the transmission information and the user touches the virtual object.

(15)

The information processing device according to (14),

in which the output control unit causes the display unit to display the image including the onomatopoeic word in a case where the stimulation output unit is determined to be not capable of outputting the target tactile stimulation.

(16)

The information processing device according to any one of (12) to (15),

in which the determination unit further determines presence or absence of reception information or transmission information of the stimulation output unit, and

the output control unit changes visibility of the image including the onomatopoeic word on the basis of target tactile stimulation corresponding to how the user touches the virtual object and an amount of tactile stimulation outputted from the stimulation output unit in a case of determining that there is the reception information or the transmission information and the user touches the virtual object.

(17)

The information processing device according to any one of (3) to (16),

in which the output control unit controls display of the image including the onomatopoeic word further depending on whether or not the virtual object is displayed by a plurality of display units.

(18)

The information processing device according to (17),

in which the output control unit causes the plurality of display units to display the image including the onomatopoeic word by rotating the image in a case where the virtual object is displayed by the plurality of display units.

(19)

An information processing method including:

acquiring motion information of a user with respect to a virtual object displayed by a display unit; and

controlling, by a processor, display of an image including an onomatopoeic word depending on the motion information and the virtual object.

(20)

A program causing a computer to function as:

an acquisition unit configured to acquire motion information of a user with respect to a virtual object displayed by a display unit; and

an output control unit configured to control display of an image including an onomatopoeic word depending on the motion information and the virtual object.

(21)

The information processing device according to (14) or (15),

wherein the output control unit, in a case where the stimulation output unit is determined to be capable of outputting the target tactile stimulation, causes the stimulation output unit to display the target tactile stimulation and causes the display unit not to display the image including the onomatopoeic word.

### REFERENCE SIGNS LIST

10 information processing device
20 stimulation output unit
30 HMD
32 communication network
100 control unit
102 information acquisition unit
104 determination unit
106 selection unit
108 output control unit
120 communication unit
122 storage unit
124 object DB

1. An information processing device comprising:
an acquisition unit configured to acquire motion information of a user with respect to a virtual object displayed by a display unit; and
an output control unit configured to control display of an image including an onomatopoeic word depending on the motion information and the virtual object.

2. The information processing device according to claim 1,
wherein the acquisition unit further acquires attribute information associated with the virtual object, and
the output control unit controls display of the image including the onomatopoeic word depending on the motion information and the attribute information.

3. The information processing device according to claim 2, further comprising:
a determination unit configured to determine whether or not the user touches the virtual object on a basis of the motion information,
wherein the output control unit causes the display unit to display the image including the onomatopoeic word in a case where the determination unit determines that the user touches the virtual object.

4. The information processing device according to claim 3,
wherein the output control unit changes a display mode of the image including the onomatopoeic word depending on a direction of change in contact positions in determining that the user touches the virtual object.

5. The information processing device according to claim 3,
wherein the output control unit changes a display mode of the image including the onomatopoeic word depending on a speed of change in contact positions in determining that the user touches the virtual object.

6. The information processing device according to claim 5,
wherein the output control unit makes a display time period of the image including the onomatopoeic word smaller as the speed of change in contact positions in determining that the user touches the virtual object is higher.

7. The information processing device according to claim 5,
wherein the output control unit makes a display size of the image including the onomatopoeic word larger as the speed of change in contact positions in determining that the user touches the virtual object is higher.

8. The information processing device according to claim 3, further comprising:
a selection unit configured to select any one of a plurality of types of onomatopoeic words depending on the attribute information,
wherein the output control unit causes the display unit to display an image including an onomatopoeic word selected by the selection unit.

9. The information processing device according to claim 8,
wherein the selection unit selects any one of the plurality of types of onomatopoeic words further depending on a direction of change in contact positions in determining that the user touches the virtual object.

10. The information processing device according to claim 8,
wherein the selection unit selects any one of the plurality of types of onomatopoeic words further depending on a speed of change in contact positions in determining that the user touches the virtual object.

11. The information processing device according to claim 8,
wherein the selection unit further selects any one of the plurality of types of onomatopoeic words further depending on a profile of the user.

12. The information processing device according to claim 3,
wherein the output control unit causes a stimulation output unit to output stimulation relating to a tactile sensation further depending on the motion information and the attribute information in the case where the determination unit determines that the user touches the virtual object.

13. The information processing device according to claim 12,
wherein the determination unit further determines presence or absence of reception information or transmission information of the stimulation output unit, and
the output control unit causes the display unit to display the image including the onomatopoeic word in a case of determining that there is no reception information or transmission information and the user touches the virtual object.

14. The information processing device according to claim 12,
wherein the determination unit further determines presence or absence of reception information or transmission information of the stimulation output unit, and
the output control unit causes the display unit to display the image including the onomatopoeic word on a basis of target tactile stimulation corresponding to how the user touches the virtual object and information relating to tactile stimulation that can be outputted by the stimulation output unit in a case of determining that there is the reception information or the transmission information and the user touches the virtual object.

15. The information processing device according to claim 14,
wherein the output control unit causes the display unit to display the image including the onomatopoeic word in a case where the stimulation output unit is determined to be not capable of outputting the target tactile stimulation.

16. The information processing device according to claim 12,
wherein the determination unit further determines presence or absence of reception information or transmission information of the stimulation output unit, and
the output control unit changes visibility of the image including the onomatopoeic word on a basis of target tactile stimulation corresponding to how the user touches the virtual object and an amount of tactile stimulation outputted from the stimulation output unit in a case of determining that there is the reception information or the transmission information and the user touches the virtual object.

17. The information processing device according to claim 3,
wherein the output control unit controls display of the image including the onomatopoeic word further depending on whether or not the virtual object is displayed by a plurality of display units.

18. The information processing device according to claim 17,
wherein the output control unit causes the plurality of display units to display the image including the onomatopoeic word by rotating the image in a case where the virtual object is displayed by the plurality of display units.

19. An information processing method comprising:
acquiring motion information of a user with respect to a virtual object displayed by a display unit; and
controlling, by a processor, display of an image including an onomatopoeic word depending on the motion information and the virtual object.

20. A program causing a computer to function as:
an acquisition unit configured to acquire motion information of a user with respect to a virtual object displayed by a display unit; and
an output control unit configured to control display of an image including an onomatopoeic word depending on the motion information and the virtual object.
